(19) United States
(12) Patent Application Publication
(10) Pub. No.: US 2011/0127057 A1
(43) Pub. Date: Jun. 2, 2011

(54) PORTABLE POWER TOOL, PARTICULARLY CORDLESS SCREWDRIVER OR CORDLESS DRILL

(76) Inventor: Heiko Roehm, Stuttgart (DE)

(21) Appl. No.: 12/993,025

(22) PCT Filed: Dec. 3, 2008
(86) PCT No.: PCT/EP08/66694

§ 371 Date: Nov. 16, 2010

(30) Foreign Application Priority Data
May 16, 2008 (DE) 10 2008 001 829.5

(51) Int. Cl. B25F 5/02

(52) U.S. Cl. 173/162.2

(57) ABSTRACT

The invention is a portable power tool having a drive motor disposed in a housing and a removable housing cover, and also a damping element adjoining the housing cover. In an assembled state of the housing cover on the housing, the housing cover can carry out a relative motion with respect to the housing, the damping element being disposed between the housing and the housing cover.

The invention relates to a portable power tool, for instance to a cordless screwdriver or a cordless drill, as generically defined by the preamble to claim 1.

### PRIOR ART

In U.S. Patent Disclosure 2002/0096341 A1, a cordless drill or cordless screwdriver is described which has an electric drive motor in a housing, which motor is supplied with current via a battery pack to be connected to the housing and drives a tool to rotate, the tool being received in a tool mount. In the vicinity of the electric drive motor, the housing is provided with a housing cover, which is to be connected to the housing via a plurality of screws; with the housing cover removed, a housing opening is uncovered by way of which the electric drive motor is introduced into the housing and can be removed from it.

For reasons of strength and safety, the housing cover is spray-coated on its outside with a thermoplastic elastomer, which provides additional impact and shock absorption and thus protects the housing cover, for instance in the event that the portable power tool is dropped and hits the floor.

### DISCLOSURE OF THE INVENTION

With this prior art as the point of departure, it is the object of the invention to improve the durability and operating safety of a portable power tool with simple provisions. Preferably, this should be done in the vicinity of the housing.

This object is attained according to the invention with the characteristics of claim 1. The dependent claims recite expedient refinements.

The portable power tool of the invention has a drive motor in a housing, preferably an electric drive motor, and it is for instance a cordless screwdriver, a cordless drill/screwdriver, or a cordless power impact drill, but portable power tools without the capability of cordless operation can also be considered. The housing is meant to be closed by a housing cover, which is preferably located adjacent to the drive motor. With the cover open, at least part of the drive motor is accessible in the housing, so that the drive motor can be introduced or removed, or individual parts of the drive motor can be replaced, such as the carbon brushes of the electric drive motor. The housing cover is embodied in such a way or to be secured in such a way on the housing that in the installed state, the housing cover can execute a relative motion to the housing. Moreover, a damping element is provided, which is disposed between the housing and the housing cover.

This embodied makes improved damping possible between the housing and the housing cover, without impairing the external visual appearance by the provision of externally located damping elements. In the embodiment according to the invention, the damping element is instead located between the housing and the housing cover, and not on the outside of the housing as is the case in the prior art. By integrating the damping element with an internal region of the portable power tool, additional design possibilities are available without restricting the damping function.

At the same time, the damping action is improved in comparison to the prior art, since vibration, oscillation and shocks are not transmitted, or transmitted only in considerably reduced form, between the housing and the housing cover. For instance, shocks and impacts that act on the housing cover from outside are conducted onward to the housing with the drive motor, located in it, in only a severely greatly damped way. Conversely, vibration that occurs during operation of the portable power tool from machining of the workpiece and optionally from the drive motor are not carried onward, or are carried onward only to a reduced extent, to the housing cover, which is preferably located on the side of the housing opposite the tool mount. Thus there is damping in two directions, both from the housing cover to the housing and in the opposite direction. The housing cover is therefore exposed to a reduced load, which leads to more-ergonomic work in the event that the user grasps the portable power tool by the housing cover, and furthermore reduces the danger that the mounted housing cover will come loose unintentionally because of the vibration.

The housing cover is advantageously connected to the housing via a connecting element, for instance via at least one screw; in a preferred embodiment, the housing cover in the installed state is relatively displaceable with respect to the housing along the axis of the connecting element or in the connecting direction. As a result, the effect can be attained that the damping element forces the housing cover outward, that is, away from the housing, counter to the retention force of the connecting element. The connecting element pulls the housing cover toward the intervening damping element in the direction of the housing; an additional exertion of force from outside, for instance, on the housing cover along the axis of the connecting element leads to a relative displacement of the housing cover compared to the damping element and as a result to additional damping. At the same time, it is ensured that the housing cover cannot come loose from the housing.

The damping element expediently comprises a viscoelastic material. As materials for the damping element, NBR, PUR, EPDM, SI, SBR, IR, TPE, NR, or some other elastic material with damping properties can be considered. The structure of the damping element can be embodied in foamed fashion or of solid material. Alternatively, the damping element can be made from an elastic material, such as steel, with a suitable geometric design.

The housing and the housing cover can be made from different materials; for instance, a plastic housing and a housing cover of a more-solid material, such as metal, can be considered. That has the advantage that on the one hand an appealing visual design is achieved, since the metal housing cover lends a high-quality impression. On the other, because of the choice of harder material, it is possible for the housing cover on the power tool to be made an auxiliary tool, for instance for hammering or for driving dowels into the wall without causing damage to the housing cover. The-point-type loads that occur in such operations are also, because of the intervening damping element, conducted onward only in a correspondingly reduced way to the housing and to the drive motor located in it.

In a further expedient embodiment, the damping element comprises an electrically insulating material, which insulates electrically conductive components from the cover, particularly when the cover is made of an electrically conductive metal. Depending on the choice of material, the electrically insulating property can be combined with the viscoelasticity of the damping element.

Further advantages and expedient embodiments can be learned from the further claims, the description of the drawings, and the drawings. In the drawings:

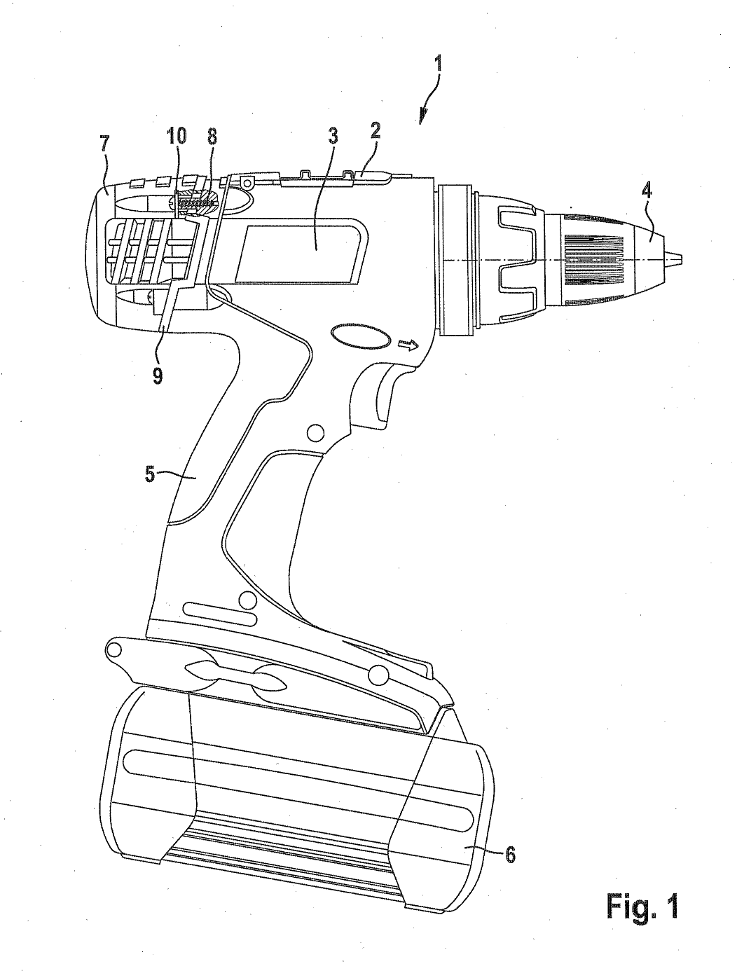

FIG. 1 shows a portable power tool, embodied as a cordless screwdriver or cordless drill, in the motor housing of which an electric drive motor is received; on the side of the motor housing facing the receiving holder for the tool, there is a housing cover, and a damping element is positioned between the motor housing and the housing cover;

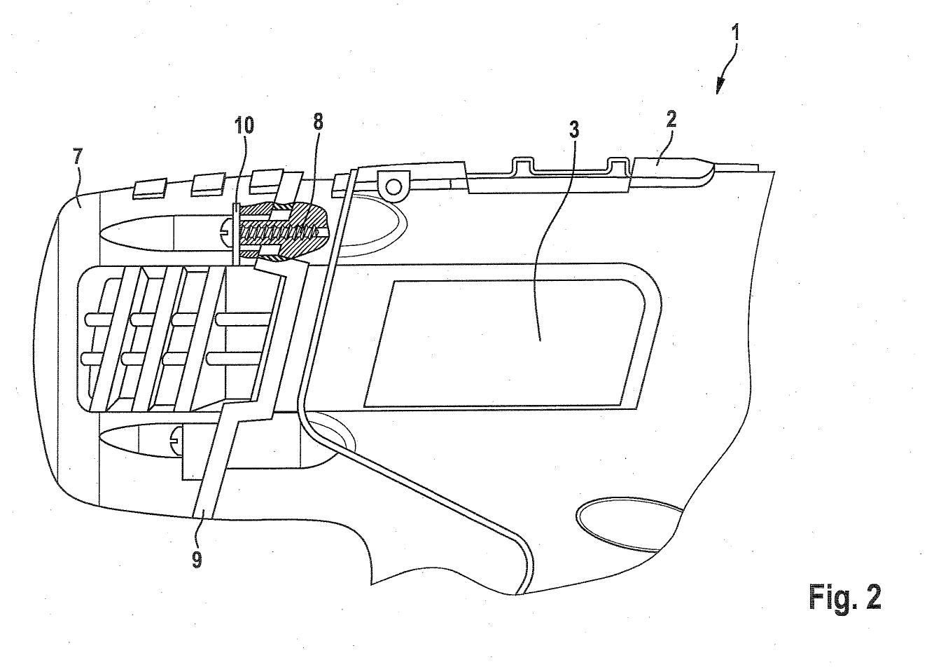

FIG. 2 shows an enlarged detail of the rear region of the housing of the portable power tool, with the transition between motor housing and the housing cover.

In the drawings, identical components are identified by the same reference numerals.

The portable power tool 1, in a motor housing 2 which is made for instance as a plastic housing, has an electric drive motor 3, by way of which a tool, such as a screwdriver or drill, received in a tool mount can be driven to rotate. The motor housing 2, below the portion having the drive motor 3, forms a handle 5, on the underside of which a battery pack 6 can be detachably flanged on for supplying power to the electric drive motor 3.

On the side opposite the tool mount 4, there is a housing cover 7 on the motor housing 2, and this cover closes an opening in the housing by way of which parts of the electric drive motor, such as carbon brushes, can be replaced. The opening in the motor housing, in the installed state of the housing cover 7 as well, like the tool mount 4, are located along the motor axis of the drive motor 3.

The housing cover 7 is meant to be detachably connected to the motor housing 2. For that purpose, a connecting element 8 is provided, which in the exemplary embodiment is embodied as a connecting screw and by way of which the housing cover 7 is retained on the motor housing 2 in the installed state.

Between the motor housing 2 and the housing cover 7 is a damping element 9, which advantageously extends over the entire connecting region between the housing and the housing cover, so that there is no direct contact between the housing cover 7 and the motor housing 2. Expediently, the connecting element 8 is also embodied in such a way that a relative displacement of the housing cover 7 along the axis of the drive motor 3 is possible. Thus the connecting element 8 is assigned only a loosely securing function. This is achieved in the exemplary embodiment shown by providing that, on the connecting element 8 embodied as a screw, a disk 10 is disposed which keeps the housing cover 7 on the motor housing 2 in such a way that the housing cover 7, with the connecting element installed, moves in the direction of the motor housing 2 but cannot be moved away from the motor housing. In the installed position, the connecting element 8 presses the housing cover 7 against the damping element 9, which builds up a correspondingly high counterforce in order to avoid play and to keep the housing cover 7 without play on the housing 2.

Because of the deformability of the damping element 9, point-type loads, such as shocks or impacts on the outside of the housing cover 7 in the direction of the motor axis, cause a slight relative displacement of the housing cover 7 in the direction of the motor housing 2, and this displacement motion is absorbed and correspondingly damped by the damping element 9. In the opposite direction, oscillation and vibration, which occur in operation of the portable power tool in machining the workpiece, are likewise not transmitted directly from the motor housing 2 to the housing cover 7 but rather are partly or entirely absorbed by the intervening damping element.

In principle, structural embodiments are also conceivable in which the housing cover 7 can perform additional or alternative motion options relative to the motor housing 2; it must be ensured that the housing cover 7 is retained in captive fashion on the motor housing and that the relative motion between the housing cover and the motor housing is damped by the damping element. As further motion options, all rotational and translational degrees of freedom can be considered, which may be present either individually or in combination.

1-13. (canceled)

14. A portable power tool, in particular a cordless screwdriver or cordless drill, comprising:
a drive motor disposed in a housing which has a removable housing cover; and
a damping element adjoining the housing cover and being disposed between the housing and the housing cover, wherein the housing cover in an installed state can execute a relative motion relative to the housing.

15. The portable power tool as defined by claim 14, wherein the housing cover is disposed adjacent to the drive motor.

16. The portable power tool as defined by claim 14, wherein the housing cover is connected to the housing via at least one connecting element.

17. The portable power tool as defined by claim 15, wherein the housing cover is connected to the housing via at least one connecting element.

18. The portable power tool as defined by claim 16, wherein the housing cover in the installed state is relatively displaceable with respect to the housing along an axis of the connecting element.

19. The portable power tool as defined by claim 17, wherein the housing cover in the installed state is relatively displaceable with respect to the housing along an axis of the connecting element.

20. The portable power tool as defined by claim 16, wherein the damping element forces the housing cover away from the housing, counter to a retention force of the connecting element.

21. The portable power tool as defined by claim 17, wherein the damping element forces the housing cover away from the housing, counter to a retention force of the connecting element.

22. The portable power tool as defined by claim 18, wherein the damping element forces the housing cover away from the housing, counter to a retention force of the connecting element.

23. The portable power tool as defined by claim 19, wherein the damping element forces the housing cover away from the housing, counter to a retention force of the connecting element.

24. The portable power tool as defined by claim 14, wherein the damping element extends at least essentially over an entire connecting region between the housing and the housing cover.

25. The portable power tool as defined by claim 20, wherein the damping element extends at least essentially over an entire connecting region between the housing and the housing cover.

26. The portable power tool as defined by claim 21, wherein the damping element extends at least essentially over an entire connecting region between the housing and the housing cover.

27. The portable power tool as defined by claim 14, wherein the damping element comprises a viscoelastic material.

28. The portable power tool as defined by claim 14, wherein the damping element comprises an elastic material.

29. The portable power tool as defined by claim 14, wherein the damping element comprises an electrically insulating material.

30. The portable power tool as defined by claim 14, wherein the housing and the housing cover comprise different materials.

31. The portable power tool as defined by claim 14, wherein the housing cover is made from metal.

32. The portable power tool as defined by claim 14, wherein the housing comprises plastic.

33. The portable power tool as defined by claim 14, wherein the damping element at least partly covers an inner wall of the housing cover.
